(19) United States
(12) Patent Application Publication
(10) Pub. No.: US 2007/0184978 A1
(43) Pub. Date: Aug. 9, 2007

(54) Thermosensitive recording material and method of producing the same

(76) Inventors: Shinji Takano, Numazu-shi (JP); Hiroaki Matsui, Numazu-shi (JP)

Correspondence Address: COOPER & DUNHAM, LLP, 1185 AVENUE OF THE AMERICAS, NEW YORK, NY, 10036, US

(21) Appl. No.: 11/701,079

(22) Filed: Jan. 31, 2007

(30) Foreign Application Priority Data
Feb. 3, 2006 (JP) 2006-027700

(51) Int. Cl. B41M 5/24

(52) U.S. Cl. 503/226

(57) ABSTRACT

A thermosensitive recording material and the method of producing the same are provided, in which the protective layer-coating liquid represents superior temporal stability, transporting ability at printing is superior even under higher temperatures and humidities and even by use of printers with lower motor torque, and also coloring property and storage property at image and background portions are excellent. The thermosensitive recording material comprises comprises at least a support, a thermosensitive recording layer and a protective layer in order, wherein the thermosensitive recording layer comprises at least a leuco dye and a color developer, and the protective layer is formed from a protective layer-coating liquid comprising at least a diacetone-modified polyvinyl alcohol, a carbodihydrazide compound and an aqueous ammonia solution.

### BACKGROUND OF THE INVENTION

1. Field of the Invention

The present invention relates to thermosensitive recording materials and methods for producing the same, in which protective layer-coating liquid exhibits superior temporal stability, transporting ability at printing is proper even under higher temperatures and humidities, and also coloring property and storage property at image and background portions are excellent.

2. Description of the Related Art

Thermosensitive recording materials are typically produced by disposing thermosensitive recording layers, having an essential component of thermal coloring compositions, on supports such as paper, synthetic paper and plastic films; their color images may be developed through heating by use of thermal heads, thermal pens, laser lights and flash lamps. These thermosensitive recording materials may provide various advantages, for example, elaborate treatments such as developing and fixing are unnecessary, images may be produced promptly using relatively simple apparatuses, environmental noise and pollution are relatively low, and the cost is relatively inexpensive; therefore, they are utilized for a wide variety of applications including copies of documents or literatures, or printings in computers, facsimiles, ticket-vending devices, labels and recorders.

The thermal coloring compositions in the thermosensitive recording materials typically contain a coloring agent, and a color developer for thermally developing the coloring agent. The coloring agent may be lactones, lactams, or colorless or pale leuco dyes having a spiropyran ring. The color developer may be organic acids or phenol compounds. Recording materials with these coloring agents and color developers may advantageously represent clear image tone, higher whiteness of background, and superior durability of images, thus are widely utilized for various printers under different conditions. However, there arise some problems such as inferior transporting ability at printing under higher temperatures and humidities when the printing is carried out using printers with lower motor torque, since thermosensitive recording materials are widely and differently utilized and printers are miniaturized and power-saved.

Recently, in order to improve printing quality in terms of coloring sensitivity and color density, under layers, containing fine hollow particles of non-foamed plastic, are often provided into thermosensitive recording materials so as to effectively make use of thermal energy from thermal heads and to enhance insulative effect. The balloons within the fine hollow particles may exhibit high cushioning effect, thus bring about intimate contact between thermal heads and thermosensitive recording materials, resulting in superior coloring property. However, the intimate contact between thermal heads and thermosensitive recording materials tends to cause sticking between them, increase friction resistance, and deteriorate transporting ability at printing under higher temperatures and humidities when using printers with lower motor torque.

In order to solve these problems, various approaches have been tried to enhance slipping property of thermosensitive recording materials. Japanese Patent Application Laid-Open (JP-A) No. 59-91090 proposes a protective layer that contains a room temperature-curable silicone resin or a silicone oil to form a releasable film on the surface.

JP-A No. 02-178084 and JP-A No. 03-57693 propose also a protective layer that contains a water-soluble silicone oil or a modified silicone oil.

However, these proposals suffer from insufficient effect upon pressing by printers and inferior printing properties in terms of ink deposition and binding force, since it is nothing more than that a silicone oil film with higher water-repellency is formed for the purpose of a protective layer, thus these proposals are impractical.

In addition, JP-A No. 01-262186 and JP-A No. 02-220886 propose addition of organic particles such as maleimido-containing polymer and organic fine particles into protective layers in order to enhance transporting ability. However, non-sticking cannot be compatible with improvement in matching or lubrication with thermosensitive recording materials, thus these proposals resulting in insufficient effect.

JP-A No. 11-314457 and JP-A No. 2002-127601 propose addition of a diacetone-modified polyvinyl alcohol resin and a cross-linking agent into protective layers in order to enhance water resistance. However, these proposals suffer from poor coating ability since the cross-linking agent is active in the cross-linking reaction, which leading to shorter pot life and poor liquid stability.

Accordingly, such a thermosensitive recording material is still commercially unavailable that exhibits superior temporal stability of the protective layer-coating liquid, proper transporting ability at printing under higher temperatures and humidities even by use of printers with lower motor torque, and excellent coloring property and storage property at image and background portions, thus prompt attainment thereof is currently demanded.

### SUMMARY OF THE INVENTION

The present invention aims to solve the problems in the art described above; that is, it is an object of the present invention to provide a thermosensitive recording material that exhibits superior temporal stability of the protective layer-coating liquid, proper transporting ability at printing under higher temperatures and humidities even by use of printers with lower motor torque, and also excellent coloring property and storage property at image and background portions; it is another object of the present invention to provide a method for producing the thermosensitive recording material.

The object described above may be attained by the present invention; that is, the present invention provides a thermosensitive recording material, comprising at least a support, a thermosensitive recording layer and a protective layer in order, wherein the thermosensitive recording layer comprises at least a leuco dye and a color developer, and the protective layer is formed from a protective layer-coating liquid comprising at least a diacetone-modified polyvinyl alcohol, a carbodihydrazide compound and an aqueous ammonia solution.

Preferably, the ammonia content in the protective layer-coating liquid is 0.0005 to 0.01 part by mass based on one part by mass of the diacetone-modified polyvinyl alcohol.

Preferably, pH of the protective layer-coating liquid is 6 to 8.

Preferably, the coated amount of the protective layer-coating liquid is 1.0 to 5.0 g/m² as dry mass.

Preferably, the carbodihydrazide compound comprises adipic dihydrazide, and the content of the carbodihydrazide compound in the protective layer is 0.1 to 0.3 part by mass based on one part by mass of the diacetone-modified polyvinyl alcohol.

Preferably, the protective layer comprises a pigment, the pigment comprises aluminum hydroxide having an average particle diameter of 0.5 to 2.0 μm, and the content of the pigment is 1 to 3 parts by mass based on one part by mass of the diacetone-modified polyvinyl alcohol.

Preferably, the protective layer comprises a lubricant, the lubricant comprises a room temperature-curable silicone rubber, and the content of the room temperature-curable silicone rubber is 0.01 to 0.1 part by mass based on one part by mass of the diacetone-modified polyvinyl alcohol.

Preferably, the protective layer comprises a fluorescent whitening agent, and the fluorescent whitening agent comprises a diaminostilbene compound.

Preferably, the leuco dye is one of 2-anilino-3-methyl-6- (di-n-butylamino)fluorane and 2-anilino-3-methyl-6-(di-n-pentylamino)fluorane.

Preferably, the color developer comprises a diphenylsulfone compound, and the content of the color developer is 1 to 5 parts by mass based on one part of the leuco dye.

Preferably, the thermosensitive recording material further comprises an under layer between the thermosensitive recording material and the protective layer, and the under layer comprises a binder resin and hollow particles.

Preferably, the thermosensitive recording material further comprises a back layer on the side of the support opposite to the thermosensitive recording layer.

Preferably, the thermosensitive recording material further comprises an adhesive layer on the side of the support opposite to the thermosensitive recording layer, and a release paper is disposed on the adhesive layer, thereby to form a thermosensitive recording label.

Preferably, the thermosensitive recording material further comprises a thermosensitive adhesive layer, which being tacky upon heating, on the side of the support opposite to the thermosensitive recording layer, thereby to form a thermosensitive recording label.

Preferably, the thermosensitive recording material further comprises a magnetic recording layer on the side of the support opposite to the thermosensitive recording layer, thereby to form a thermosensitive magnetic recording paper.

Preferably, the thermosensitive recording material described above has a shape of label, sheet or roll.

In another aspect, the present invention provides a method for producing a thermosensitive recording material, comprising at least a support, a thermosensitive recording layer and a protective layer in order, wherein the protective layer is formed by coating and drying a protective layer-coating liquid on the thermosensitive recording layer, and the protective layer-coating liquid comprises at least a diacetone-modified polyvinyl alcohol, a carbodihydrazide compound and an aqueous ammonia solution.

Preferably, the ammonia content in the protective layer-coating liquid is 0.0005 to 0.01 part by mass based on one part by mass of the diacetone-modified polyvinyl alcohol.

Preferably, pH of the protective layer-coating liquid is 6 to 8.

Preferably, the coated amount of the protective layer-coating liquid is 1.0 to 5.0 g/m² as dry mass.

The thermosensitive recording material according to the present invention comprises at least a support, a thermosensitive recording layer and a protective layer in order, wherein the thermosensitive recording layer comprises at least a leuco dye and a color developer, and the protective layer is formed from a protective layer-coating liquid comprising at least a diacetone-modified polyvinyl alcohol, a carbodihydrazide compound and an aqueous ammonia solution. As a result, the protective layer-coating liquid represents superior temporal stability, transporting ability at printing is superior even under higher temperatures and humidities and even by use of printers with lower motor torque, and also coloring property and storage property at image and background portions are excellent, and thus high-quality recording may be attained.

The present invention may solve the problems in the art, that is, thermosensitive recording materials may be provided, in which the protective layer-coating liquid represents superior temporal stability, transporting ability at printing is superior even under higher temperatures and humidities and even by use of printers with lower motor torque, and also coloring property and storage property at image and background portions are excellent.

### DESCRIPTION OF THE PREFERRED EMBODIMENTS

Thermosensitive Recording Material and Method for Producing the Same

The thermosensitive recording material according to the present invention comprises a support, a thermosensitive recording layer and a protective layer in order, and also optional other layers such as a back layer and an under layer.

The inventive method for producing a thermosensitive recording material comprises a step of coating and drying a protective layer-coating liquid on the thermosensitive recording layer to form the protective layer and optional other steps, in which the protective layer-coating liquid comprises at least a diacetone-modified polyvinyl alcohol, a carbodihydrazide compound and an aqueous ammonia solution.

The inventive thermosensitive recording medium will be explained in the following, along which the inventive method for producing the thermosensitive recording material will be apparent.

Protective Layer

The protective layer is formed from a protective layer-coating liquid that comprises at least a diacetone-modified polyvinyl alcohol (PVA), a carbodihydrazide compound, an aqueous ammonia solution and optional other ingredients as required.

Diacetone-Modified Polyvinyl Alcohol

The “diacetone-modified polyvinyl alcohol” as used herein means a partially or completely saponified copolymer formed from a monomer with diacetone group and a vinyl ester, which may be produced by saponifying the copolymer of the monomer and the vinyl ester. The diacetone-modified polyvinyl alcohol may exhibit lower swelling rates in water and thus scarcely swell under higher temperatures and humidities by virtue of its molecular structure compared to conventional resins, typically used for protective layers, such as polyvinyl alcohol, carboxylic acid-modified polyvinyl alcohol, silicone-modified polyvinyl alcohol, methylcellulose, casein and gelatin, which leading to mitigation of thermal head depositions and appropriate transporting ability at printing.

The content of the diacetone-modified polyvinyl alcohol is preferably 10 to 50% by mass in the protective layer, more preferably 20 to 40% by mass.

Carbodihydrazide Compound

A carbodihydrazide compound is added as a cross-linking agent for the diacetone-modified polyvinyl alcohol in order to improve water resistance. The carbodihydrazide compound may be properly selected depending on the application; examples thereof include, but not limited to, oxalic dihydrazide, malonic dihydrazide, succinic dihydrazide, adipic dihydrazide, sebacic dihydrazide, dodecanedioic acid dihydrazide, maleic dihydrazine, itaconic dihydrazide, glutaric dihydrazide, tartaric dihydrazide, malic dihydrazide and terephthalic dihydrazide 2,7-naphthoic dihydrazide . These may be used alone or in combination. Among these dihydrazide compounds, adipic dihydrazide is preferable from the viewpoint of water resistance and safety.

The content of the dihydrazide compound is preferably 0.1 to 0.3 part by mass based on 1 part by mass of the diacetone-modified polyvinyl alcohol. The content of below 0.1 part by mass may result in poor water resistance and transporting ability at printing under higher temperatures and humidities; and the content of above 0.3% by mass may cause problem in pot life of the protective layer-coating liquid due to excessively active cross-linking reaction.

Aqueous Ammonia Solution

The carbodihydrazide compounds described above may be properly used as a cross-linking agent for the diacetone-modified polyvinyl alcohol; on the other hand, the carbodihydrazide compounds may induce prompt cross-linking reaction, which possibly leading to shorter pot life of the protective layer-coating liquid and problematic coating stability in practical use. The reaction described above tends to easily progress under acidic conditions, therefore, the reaction may be suppressed by adding aqueous ammonia solution to adjust the pH into alkali. Specifically, pH 6 to 8 of the protective layer-coating liquid may promise a certain pot life.

Furthermore, ammonia in the aqueous ammonia solution may easily evaporate from coated films at the step of coating and drying in contrast to solid bases, thus far from inhibiting the cross-linking reaction in the coated and dried films for the protective layer. The content of the ammonia is preferably 0.0005 to 0.01 part by mass based on one part of the diacetone-modified polyvinyl alcohol, more preferably 0.001 to 0.005 part by mass. The content of below 0.0005 part by mass may be ineffective for suppression of the cross-linking reaction and resulting possibly in prompt gelatinization, and the content of above 0.01 part by mass may lead to residual ammonia in films after coating and drying, which possibly leading to inhibition of the cross-linking reaction and resulting poor quality of water resistance etc.

It is preferred that a pigment is added to the protective layer in order to improve matching with heads. The usable pigment is exemplified by inorganic pigments such as silica and calcium carbonate and organic pigments such as cross-linked polystyrene resins and urea-formalin resins; preferably, aluminum hydroxide is employed in view of abrasion at head matching, deposition of head dusts and chemical resistance.

The average particle diameter of the pigment is preferably 0.5 to 2.0 μm. The average particle diameter affects the quality of thermosensitive recording material; specifically, the average particle diameter of above 2.0 μm possibly leads to higher abrasion and poor chemical resistance and the diameter of below 0.5 μm may bring about significant increase in deposition of head dusts. The content of the pigment is preferably 1 to 3 parts by mass based on one part of the diacetone-modified polyvinyl alcohol. The pigment content of below 1 part by mass may degrade the transporting ability at printing under higher temperatures and humidities; the pigment content of above 3 parts by mass may significantly increase the abrasion of thermal heads.

A lubricant such as fatty acid metal salts, higher fatty acid amides and higher fatty acid esters may be added to the protective layer in order to improve head matching by virtue of additional lubricating ability. A room-temperature curable silicone rubber is favorably employed for the protective layer in view of the transporting ability at printing under higher temperatures and humidities. The reason of the room-temperature curable silicone rubber being excellent is believed not only due to superior releasing or lubricating ability but also water-repellency derived from silicone. The content of the room temperature-curable silicone rubber is 0.01 to 0.1 part by mass based on one part by mass of the diacetone-modified polyvinyl alcohol. When the content is less than 0.01 part by mass, the transporting ability at printing may be inferior under higher temperatures and humidities; when the content is more than 0.1 part, the barrier ability may degrade, consequently resulting in easy infiltration of chemicals like plasticizer and/or degradation of chemical resistance.

In order to improve coating property and/or binding ability of the coating layer, a binder may also be added; examples thereof include, but not limited to, starches, hydroxyethylcellulose, methylcellulose, carboxymethylcellulose, gelatin, casein, acacia gum, polyvinyl alcohol, diisobutylene/maleic anhydride copolymer salts, styrene/maleic anhydride copolymer salts, ethylene/acrylic acid copolymer salts, styrene/acrylic acid copolymer salts, and emulsions of styrene/butadiene copolymer salts.

In addition, a filler, surfactant, heat-meltable substance, fluorescent whitening agent or other auxiliary agents may be added as required. It is preferred that the fluorescent whitening agent, which being often employed for purpose of whitening and appearance, is a diaminostilbene compound in view of stability of the protective layer-coating liquid.

The diaminostilbene compound is exemplified by 4,4′-diaminostilbene-2,2′-disulfonic acid derivatives and 10 4,4′-bistriazinylaminostilbene-2,2′-disulfonic acid derivatives.

The content of the fluorescent whitening agent is preferably 0.01 to 0.1 part by mass based on one part by mass of the diacetone-modified polyvinyl alcohol.

The preferable method for forming the protective layer is, for example, such that a protective layer-coating liquid, comprising a diacetone-modified polyvinyl alcohol, a carbodihydrazide compound, an aqueous ammonia solution and optional other ingredients, is coated and dried on the thermosensitive recording layer or the under layer.

The coating process may be of blade coating, gravure coating, gravure offset coating, bar coating, roll coating, knife coating, air knife coating, comma coating, U-comma coating, AKKU coating, smoothing coating, micro gravure coating, reverse roll coating, 4-roll or 5-roll coating, dip coating, curtain coating, slide coating or die-coating.

The drying temperature may be properly selected depending on the application; preferably, the temperature is about 100° C. to 250° C. The coated amount of the protective layer-coating liquid is preferably 1.0 to 5.0 g/m² as dry mass, more preferably 2.0 to 4.0 g/m².

Thermosensitive Recording Layer

The thermosensitive recording layer contains at least a leuco dye, a color developer and other optional ingredients as required.

Leuco Dye

The leuco dye may be properly selected depending on the purpose; examples of the leuco dye include triphenylmethanes, fluorans, phenothiazines, auramines, spiropyranes and indolinophthalides.

Specific examples of the leuco dye are
2-anilino-3-methyl-6-(di-n-butylamino)fluoran,
2-anilino-3-methyl-6-(di-n-pentylamino)fluoran,
2-anilino-3-methyl-6-[ethyl(4-methylphenyl)amino]fluoran,
3,3-bis(p-dimethylaminophenyl)-phthalide,
3,3-bis(p-dimethylaminophenyl)-6-dimethylaminophthalide (also known as Crystal Violet lactone),
3,3-bis(p-dimethylaminophenyl)-6-diethylaminophthalide,
3,3-bis(p-dimethylaminophenyl)-6-chlorophthalide,
3,3-bis(p-dibutylaminophenyl)phthalide,
3-cyclohexylamino-6-chlorofluoran,
3-dimethylamino-5, 7-dimethylfluoran,
3-(N-methyl-N-isobutyl)-6-methyl-7-anilinofluoran,
3-(N-ethyl-N-isoamyl)-6-methyl-7-anilinofluoran,
3-diethylamino-7-chlorofluoran, 3-diethylamino-7-methylfluoran,
3-diethylamino-7, 8-benzofluoran,
3-diethylamino-6-methyl-7-chlorofluoran,
3-(N-p-tolyl-N-ethylamino)-6-methyl-7-anilinofluoran,
3-pyrrolidino-6-methyl-7-anilinofluoran,
2-{N-(3′-trifluoromethylphenyl)amino}-6-diethylaminofluoran,
2-{3,6-bis(diethylamino)-9-(o-chloroanilino)xanthylbenzoic acid lactam,
3-diethylamino-6-methyl-7-(m-trichloromethylanilino)fluoran,
3-diethylamino-7-(o-chloroanilino) fluoran,
3-dibutylamino-7-(o-chloroanilino)fluoran,
3-(N-methyl-N-amylamino)-6-methyl-7-anilinofluoran,
3-(N-methyl-N-cyclohexylamino)-6-methyl-7-anilinofluoran,
3-diethylamino-6-methyl-7-anilinofluoran,
3-diethylamino-6-methyl-7-(2′, 4′-dimethylanilino)fluoran,
3-(N,N-diethylamino)-5-methyl-7-(N,N-dibenzylamino)fluoran, benzoyl leuco methylene blue,
6′-chloro-8′-methoxy-benzoindolino-spiropyran,
6′-bromo-3′-methoxy-benzoindolino-spiropyran,
3-(2′-hydroxy-4′-dimethylaminophenyl)-3-(2′-methoxy-5′-chlorophenyl)phthalide, 3-(2′-hydroxy-4′-dimethylaminophenyl)-3-(2′-methoxy-5′-nitrophenyl)phthalide, 3-(2′-hydroxy-4′-diethylaminophenyl)-3-(2′-methoxy-5′-methylphenyl)phthalide,
3-(2′-methoxy-4′-dimethylaminophenyl)-3-(2′-hydroxy-4′-chloro-5′-methylphenyl)phthalide,
3-morpholino-7-(N-propyl-trifluoromethylanilino)fluoran,
3 -pyrrolidino-7-trifluoromethylanilinofluoran,
3-diethylamino-5-chloro-7-(N-benzyl-trifluoromethylanilino)fluoran,
3-pyrrolidino-7-(di-p-chlorophenyl)methylaminofluoran,
3-diethylamino-5-chloro-7-(α-phenylethylamino)fluoran,
3-(N-ethyl-p-toluidino)-7-(α-phenylethylamino)fluoran,
3-diethylamino-7-(o-methoxycarbonylphenylamino)fluoran,
3-diethylamino-5-methyl-7-(α-phenylethylamino)fluoran,
3-diethylamino-7-piperidinofluoran,
2-chloro-3-(N-methyltoluidino)-7-(p-n-butylanilino)fluoran,
3-(N-methyl-N-isopropylamino)-6-methyl-7-anilinofluoran,
3-dibutylamino-6-methyl-7-anilinofluoran,
3,6-bis(dimethylamino)fluorenespiro(9,3′)-6′-dimethylaminophthali de, 3-(N-benzyl-N-cyclohexylamino)-5, 6-benzo-7-α-naphthylamino-4′-bromofluoran, 3-diethylamino-6-chloro-7-anilinofluoran,
3-{N-ethyl-N-(2-ethoxypropyl)amino}-6-methyl-7-anilinofluoran,
3-{N-ethyl-N-tetrahydrofurfurylamino}-6-methyl-7-anilinofluoran,
3-diethylamino-6-methyl-7-mesidiono-4′, 5′-benzofluoran,
3-(p-dimethylaminophenyl)-3-{1,1-bis(p-dimethylaminophenyl)-ethylene-2-yl)phthalide, 3-(p-dimethylaminophenyl)-3-{1,1 -bis(p-dimethylaminophenyl) ethylene-2-yl}-6-dimethylaminophthalide,
3-(p-dimethylaminophenyl)-3-(1-p-dimethylaminophenyl-1-phenylethylene-2-yl)phthalide,
3-(p-dimethylaminophenyl)-3-(1-p-dimethylaminophenyl-1-p-chlorophenylethylene-2-yl)-6-dimethylaminophthalide,
3-(4′-dimethylamino-2′-methoxy)-3-(1″-p-dimethylaminophenyl-1″-p-chlorophenyl-1″, 3″-butadiene-4″-yl)benzophthalide,
3-(4′-dimethylamino-2′-benzyloxy)-3-(1″-p-dimethylaminophenyl-1″-phenyl-1″, 3″-butadiene-4″-yl)benzophthalide,
3-dimethylamino-6-dimethylamino-fluorene-9-spiro-3′-(6′-dimethylamino)phthalide, 3,3-bis{2-(p-dimethylaminophenyl)-2-(p-methoxyphenyl)ethenyl}-4,5,6,7-tetrachlorophthalide,
3-bis{1,1-bis(4-pyrrolidinophenyl)ethylene-2-yl}-5,6-dichloro-4, 7-dibromophthalide, bis(p-dimethylaminostyryl)-1-naphthalenesulfonylmethane, and bis(p-dimethylaminostyryl)-1-p-tolylsulfonylmethane. These may be used alone or in combination. Among these, 2-anilino-3-methyl-6-(di-n-butylamino)fluoran and 2-anilino-3-methyl-6-(di-n-pentylamino)fluoran are particularly preferable in view of highly sensitive coloring property and qualities such as color decay at image portions in relation to resistance under humidity/heat/light and background blushing.

The amount of the leuco dye is preferably 5 to 20% by mass in the thermosensitive recording layer, more preferably 10 to 15% by mass.

Color Developer

The color developer may be properly selected as long as capable of coloring the leuco dyes; examples thereof include phenol compounds, organic acidic compounds, inorganic acidic compounds, and esters or salts of these compounds.

Specific examples of the color developer are bisphenol A, tetrabromobisphenol A, gallic acid, salicylic acid,
3-isopropylsalicylic acid, 3-cyclohexylsalicylic acid,
3,5-di-tert-butylsalicylic acid, 3,5-di-α-methylbenzylsalicylic acid,
4,4′-isopropylidenediphenol, 1,1′-isopropylidenebis(2-chlorophenol),
4,4′-isopropyle nebis(2,6-dibromophenol),
4,4′-isopropylide nebis(2,6-dichlorophenol),
4,4′-isopropylide nebis(2-methylphenol),
4,4′-isopropylidenebis(2,6-dimethylphenol),
4,4-isopropylidenebis (2-tert-butylphenol),
4,4′-sec-butylidenediphenol, 4,4′-cyclohexylidenebisphenol,
4,4′-cyclohexylidenebis(2-methylphenol), 4-tert-butylphenol,
4-phenylphenol, 4-hydroxydiphenoxide, α-naphthol, β-naphthol,
3,5-xylenol, thymol, methyl-4-hydroxybenzoate,
4-hydroxyacetophenone, novolac phenol resins,
2,2′-thiobis(4,6-dichlorophenol), catechol, resorcin, hydroquinone, pyrogallol, fluoroglycine, fluoroglycine carboxylic acid,
4-tert-octylcatechol, 2,2′-methylenebis(4-chlorophenol),
2,2′-methylenebis(4-methyl-6-tert-butylphenol),
2,2′-dihydroxydiphenyl, p-hydroxyethylbenzoate,
p-hydroxypropylbenzoate, p-hydroxybutylbenzoate,
p-hydroxybenzylbenzoate, p-hydroxybenzoic acid-p-chlorobenzyl,
p-hydroxybenzoic acid-c-chlorobenzyl, p-hydroxybenzoic acid-p-methylbenzyl, p-hydroxybenzoic acid-n-octyl, benzoic acid, zinc salicylate, 1-hydroxy-2-naphthoic acid, 2-hydroxy-6-naphthoic acid, 2-hydroxy-6-zinc naphthoate, 4-hydroxydiphenylsulfone,
4-hydroxy-4′-chlorodiphenylsulfone, bis(4-hydroxyphenyl)sulfide,
2-hydroxy-p-toluic acid, 3,5-di-tert-butyl-zinc salicylate,
3,5-di-tert-butyl-tin salicylate, tartaric acid, oxalic acid, maleic acid, citric acid, succinic acid, stearic acid, 4-hydroxyphthalic acid, boric acid, thiourea derivatives, 4-hydroxy thiophenol derivatives,
bis(4-hydroxyphenyl)acetic acid, bis(4-hydroxyphenyl)ethylacetate,
bis(4-hydroxyphenyl)n-propylacetate,
bis(4-hydroxyphenyl)n-butylacetate,
bis(4-hydroxyphenyl)phenylacetate,
bis(4-hydroxyphenyl)benzylacetate,
bis(4-hydroxyphenyl)phenethylacetate,
bis(3-methyl-4-hydroxyphenyl)acetic acid,
bis(3-methyl-4-hydroxyphenyl)ethylacetate,
bis(3-methyl-4-hydroxyphenyl)-n-p ropylacetate,
1,7-bis(4-hydroxyphenylthio)-3,5-dioxaheptane,
1,5-bis(4-hydroxyphenylthio)-3-oxaheptane,
4-hydroxydimethylphthalate, 2,4′-dihydroxydiphenylsulfone,
4-hydroxy-4′-methoxydiphenylsulfone,
4-hydroxy-4′-ethoxydiphenylsulfone,
4-hydroxy-4′-isopropoxydiphenylsulfone,
4-hydroxy-4′-propoxydiphenylsulfone,
4-hydroxy-4′-butoxydiphenylsulfone,
4-hydroxy-4′-isopropoxydip henylsulfone,
4-hydroxy-4′-sec-butoxydiphenylsulfone,
4-hydroxy-4′-tert-butoxydiphenylsulfone,
4-hydroxy-4′-benzyloxydiphenylsulfone,
4-hydroxy-4′-phenoxydiphenylsulfone,
4-hydroxy-4′-(m-methylbenzyloxy)diphenylsulfone,
4-hydroxy-4′-(p-methylbenzyloxy)diphenylsulfone,
4-hydroxy-4′-(o-methylbenzyloxy)diphenylsulfone,
4-hydroxy-4′-(p-chlorobenzyloxy)diphenylsulfone and
4-hydroxy-4′-oxyallyldiphenylsulfone.

These may be used alone or in combination. Among these, diphenylsulfone compounds such as 4-hydroxy-4′-isopropoxydiphenylsulfone, 4-hydroxy-4′-oxyallyldiphenylsulfone and 2,4′-dihydroxydiphenylsulfone are particularly preferable in view of highly sensitive coloring property and qualities such as color decay at image portions in relation to resistance under humidity/heat/light and background blushing.

The mass ratio of the color developer to the leuco dye, mixed in the thermosensitive recording layer, is preferably 0.5 to 10 parts by mass, more preferably 1 to 5 parts by mass of the color developer based on one part of the leuco dye.

It is preferred that the thermosensitive recording layer contains also a heat-meltable substance. Examples of the heat-meltable substance include fatty acids such as stearic acid and behenic acid; fatty acid amides such as stearic acid amide, erucic acid amide, palmitic acid amide and behenic acid amide; N-substituted amides such as N-lauryl lauric acid amide, N-stearyl stearic acid amide and N-oleyl stearic acid amide; bis-fatty acid amides such as methylene bis-stearic acid amide, ethylene bis-stearic acid amide, ethylene bis-lauric acid amide, ethylene bis-capric acid amide and ethylene bis-behenic acid amide; hydroxy fatty acid amides such as hydroxy stearic acid amide, methylene bis-hydroxy stearic acid amide, ethylene bis-hydroxy stearic acid amide and hexamethylene bis-hydroxy stearic acid amide; metal salts of fatty acid such as zinc stearate, aluminum stearate, calcium stearate, zinc palmitate and zinc behenate,
p-benzylbiphenyl, terphenyl, triphenylmethane,
p-benzyloxybenzylbenzoate, β-benzyloxynaphthalene,
β-phenylnaphthoate, 1-hydroxy-2-phenylnaphthoate,
1-hydroxy-2-methylnaphthoate, diphenylcarbonate, benzyl terephthalate, 1,4-dimethoxynaphthalene,
1,4-diethoxynaphthalene, 1,4-dibenzyloxynaphthalene,
1,2-diphenoxyethane, 1,2-bis(4-methylphenoxyethane),
1,4-diphenoxy-2-butene, 1,2-bis(4-methoxyphenylthio)ethane, dibenzoylmethane, 1,4-diphenylthiobutane,
1,4-diphenylthio-2-butene, 1,3-bis(2-vinyloxyethoxy)benzene,
1,4-bis(2-vinyloxyethoxy)benzene, p-(2-vinyloxyethoxy)biphenyl,
p-aryloxybip henyl, dibenzoyloxymethane, dibenzoyloxypropane,
dibenzyl disulfide, 1,1-diphenylethanol, 1,1-diphenylpropanol,
p-benzyloxybenzyl alcohol, 1,3-phenoxy-2-propanol,
N-octadecylcarbamoyl-p-methoxycarbonylbenzene,
N-octadecylcarbamoylbenzene, 1,2-bis(4-methoxyphenoxy)propane,
1,5-bis(4-methoxyphenoxy)-3-oxapentane, dibenzyl oxalate,
bis(4-methylbenzyl)oxalate and bis(4-chlorobenzyl)oxalate. These may be used alone or in combination.

The thermosensitive recording layer may contain various materials conventionally utilized for preparing thermosensitive recording layers in addition to the color developer, leuco dye and heat-meltable substance; for example, a binding agent, cross-linking agent, pigment, surfactant, or lubricant may also be used together.

Examples of the binding agent include polyvinyl alcohol, modified-polyvinyl alcohol; starch and its derivatives; cellulose derivatives such as methoxy cellulose, hydroxyethyl cellulose, carboxymethyl cellulose, methyl cellulose, ethyl cellulose; sodium polyacrylate, polyvinyl pyrrolidone, copolymers of acrylamide/acrylic ester, terpolymers of acrylamide/acrylic ester/methacrylic acid, alkali salts of styrene/maleic anhydride copolymer, alkali salts of isobutyl/maleic anhydride copolymer, polyacrylamide, modified-polyacrylamides, copolymers of methylvinylether/maleic anhydride, carboxy-modified polyethylene, block copolymers of polyvinyl alcohol/acrylamide, melamine-formaldehyde resins, urea-formaldehyde resins; water-soluble polymers such as sodium alginate, gelatin and casein; emulsions such as of polyvinyl acetate, polyurethane, copolymers of styrene/butadiene, copolymers of styrene/butadiene/acrylate, polyacrylic acid, polyacrylate, polymethacrylate, copolymers of vinyl chloride/vinyl acetate, polybutylmethacrylate, polyvinylbutyral, polyvinyl acetal and copolymers of ethylene/vinyl acetate.

These may be used alone or in combination, and may be cured by adding a cross-linker or curing agent. The cross-linker or curing agent may be those capable of reacting with the binding agent; examples thereof include glyoxal derivatives, methylol derivatives, epichlorohydrin derivatives, epoxy compounds and acridine compounds.

Examples of the pigment include inorganic fine powders such as silica, zinc oxide, titanium oxide, aluminum hydroxide, zinc hydroxide, barium sulfate, clay, kaolin, talc, and surface-treated silica; organic fine powders such as urea-formalin resins, copolymers of styrene/methacrylic acid, polystyrene resins, and vinylidene chloride resins, copolymers of styrene/acrylate and hollow fine plastic particles.

Examples of the lubricant include higher fatty acids and metal salts thereof, higher fatty acid amides, higher fatty acid esters, animal waxes, vegetable waxes, mineral waxes and petroleum waxes.

The thermosensitive recording layer may be properly formed by conventional methods; for example, the leuco dye and the color developer are separately milled and dispersed, together with a binder and/or other ingredients, into a particle diameter of 1 to 3 μm using milling apparatuses such as ball mills, attritors and sand mills, then are mixed together with a filler, dispersion of heat-meltable substance or sensitizer as required under a pre-determined formulation, thereby to prepare a coating liquid for a thermosensitive recording layer, then which is coated on a support to prepare a thermosensitive recording layer.

The thickness of the thermosensitive recording layer depends on the composition of thermosensitive recording layers and/or application of thermosensitive recording materials; preferably, the thickness is 1 to 50 μm, more preferably 3 to 20 μm.

Support

The support may be properly selected with respect to the shape, configuration, size etc. depending on the purpose. The shape may be plate-like; the configuration may be mono-layer or laminate layer; the size may be appropriately selected depending on the size of thermosensitive recording materials etc.

The material of the support may be properly selected from inorganic and organic materials depending on the purpose. Examples of the inorganic material include glasses, quartz, silicon, silicon oxide, aluminum oxide, SiO₂ and metals. Examples of the organic material include paper such as high quality paper, art paper, coated paper and synthetic paper; cellulose derivatives such as cellulose triacetate; polyester resins such as polyethylene terephthalate (PET) and polybutylene terephthalate; polymer films such as polycarbonate, polystyrene, polymethylmethacrylate, polyethylene and polypropylene. Among these, high quality paper, art paper, coated paper and polymer films are preferable in particular. These may be used alone or in combination.

It is preferred that the support is surface-treated by way of corona discharge, oxidizing (by use of chromic acid etc.), etching, adhesive-promoting, or antistatic treatment, in order to improve adhesive ability of the coating layer. It is also preferred that a white pigment, e.g. titanium oxide, is added to the support to enhance its whiteness.

The thickness of the support may be properly selected depending on the purpose; preferably, the thickness is 50 to 2000 μm, more preferably 100 to 1000 82 m.

Under Layer

An under layer may be disposed between the protective layer and the thermosensitive recording layer. The under layer may shield oxygen that takes part in photo-oxidation reaction of the leuco dye, thus light-induced color change at background or non-printing portions may be reduced more significantly.

The under layer typically contains a binder resin, hollow particles, and optional other ingredients. The hollow particles are exemplified by fine hollow particles, having a shell of thermoplastic resins and a hollow rate of 30% to 95%, or porous pigments.

The hollow particles as used herein mean those particles that contain air or other gases within them and represent an expanded condition. The hollow rate as used herein means the ratio of the volume calculated from the averaged inside diameter of the hollow particles to the volume calculated from the averaged outside diameter.

The fine hollow particles, having a shell of thermoplastic resin and a hollow rate of 30% to 95%, are expanded hollow particles containing air or other gases inside them. The average particle diameter of the fine hollow particles is preferably 0.2 to 20 μm, more preferably 0.5 to 10 μm. The average particle diameter of outer diameter of less than 0.2 μm may suffer from difficult technology to produce hollow particles and/or insufficient roll of under layers; and the average particle diameter above 20 μm may suffer from uneven coating of thermosensitive recording layers due to inferior surface flatness of coated and dried surface or excessive amount of the coating liquid of thermosensitive recording layers for a certain uniformity. As such, it is preferred that the average particle diameter is within the range and also the particle size distribution is sharp and its fluctuation is lower. The hollow rate of the hollow fine plastic particles may be 30% or more, and more preferably 70% or more. The hollow rate of below 30% is undesirable in view of poor heat efficiency since insufficient heat insulation leads to thermal-energy effluence through the supports.

The thermoplastic resin of the shells of fine hollow particles is preferably a copolymer resin based on vinylidene chloride and acrylonitrile in particular.

The porous pigment utilized in the under layer may be, but not limited to, organic pigments such as urea/formaldehyde resins or inorganic resins such as white quartz sand.

The under layer may be formed properly depending on the purpose; preferably, a coating liquid for the under layer is coated on the thermosensitive recording layer to prepare the under layer.

The coating process may be properly selected depending on the application; examples thereof include spin coating, dip coating, kneader coating, curtain coating and blade coating processes.

The coated film may be dried as required; the drying temperature, which being selected properly depending on the purpose, is preferably about 100° C. to 250° C.

The coated amount of the under layer is preferably 1.0 to 5.0 g/m² as dry mass, more preferably 2.0 to 4.0 g/m².

Back Layer

It is preferred that the thermosensitive recording material further includes a back layer on the side of the support opposite to the thermosensitive recording layer. The back layer contains a binder resin, filler, lubricant, color pigment and other ingredients.

The binder resin is typically one of water-dispersible resins and water-soluble resins, more specifically, one of conventional water-soluble polymers and aqueous polymer emulsions.

Examples of the water-soluble polymer include polyvinyl alcohol, starch and its derivatives; cellulose derivatives such as methoxy cellulose, hydroxyethyl cellulose, carboxymethyl cellulose, methyl cellulose, ethyl cellulose; sodium polyacrylate, polyvinyl pyrrolidone, copolymers of acrylamide/acrylic ester, terpolymers of acrylamide/acrylic ester/methacrylic acid, alkali salts of styrene/maleic anhydride copolymer, alkali salts of isobutyl/maleic anhydride copolymer, polyacrylamide, sodium alginate, gelatin and casein. These may be used alone or in combination.

Examples of the aqueous polymer emulsion include acrylic ester copolymers, copolymers of styrene/butadiene, copolymers of styrene/butadiene/acrylate, vinyl acetate resins, copolymers of vinyl acetate/acrylic acid, copolymers of styrene/acrylic ester, acrylic ester resins, and polyurethane resins. These may be used alone or in combination.

The filler may be one of inorganic fillers and organic fillers. The inorganic filler may be carbonates, silicates, metal oxides, or sulfuric acid compounds. The organic filler may be, for example, silicone resins, cellulose resins, epoxy resins, nylon resins, phenol resins, polyurethane resins, urea resins, melamine resins, polyester resins, polycarbonate resins, styrene resins, acrylic resins, polyethylene resins, formaldehyde resins and polymethylmethacrylate resins.

The back layer may be formed properly depending on the purpose; preferably, a coating liquid for the back layer is coated and dried on the support.

The coating process may be properly selected depending on the application; examples thereof include spin coating, dip coating, kneader coating, curtain coating and blade coating processes.

The thickness of the back layer may be properly selected depending on the application; preferably, the thickness of the back layer is 0.1 to 20 μm, more preferably 0.3 to 10 μm.

Thermosensitive Recording Label

The thermosensitive recording label in the first embodiment, which being one of thermosensitive recording materials, has a pressure-sensitive layer, a release paper on the pressure-sensitive layer and other optional components on the back side of the support opposite to the thermosensitive recording layer. The back side may also be the surface of the back layer described above.

The material of the pressure-sensitive layer may be properly selected depending on the application; examples the material include urea resins, melamine resins, phenol resins, epoxy resins, vinyl acetate resins, copolymers of vinyl acetate/acrylate, copolymers of ethylene/vinyl acetate, acrylic resins, polyvinylether resins, copolymers of vinyl chloride/vinyl acetate, polystyrene resins, polyester resins, polyurethane resins, polyamide resins, chlorinated polyolefin resins, polyvinyl butyral resins, acrylate copolymers, methacrylate copolymers, natural rubbers, cyanoacrylate resins and silicone resins. These may be used alone or in combination.

The thermosensitive recording label in the second embodiment has a thermosensitive pressure-sensitive layer that becomes tacky upon heating and other optional components on the back side of the support opposite to the thermosensitive recording layer. The back side may also be the surface of the back layer described above. The thermosensitive pressure-sensitive layer includes a thermoplastic resin, a heat-meltable substance, and an optional adhesive auxiliary agent.

The thermoplastic resin may afford tackiness and/or adhesive force. The heat-meltable substance, which being solid at room temperature thus far from the plasticity, may represent tackiness through swelling and/or softening a resin upon heating and melting. The adhesive auxiliary agent may enhance tackiness.

Thermosensitive Magnetic Recording Paper

The thermosensitive magnetic recording paper, which being one of thermosensitive recording materials, has a magnetic recording layer and other optional components on the back side of the support opposite to the thermosensitive recording layer. The back side may also be the surface of the back layer described above.

The magnetic recording layer may be formed on the support through coating by use of iron oxide, barium ferrite or the like as well as vinyl chloride, urethane, nylon resins or the like, alternatively through sputtering with no use of resins.

The magnetic recording layer is preferably formed on the side of the support opposite to the thermosensitive recording layer, alternatively may be disposed between the support and the thermosensitive recording layer or on a part of the thermosensitive recording layer.

The shape of the thermosensitive recording material may be properly selected depending on the purpose; preferable shape is label, sheet or roll.

The process for recording the thermosensitive recording material according to the present invention may be carried out, without limitation, by use of heat pens, thermal heads, laser heat heating etc.

The thermosensitive recording materials according to the present invention may be appropriately used in a wide variety of fields such as POS field like perishable foods, lunch boxes and daily dishes; communication field like facsimile; ticketing field like ticketing devices, receipts and acknowledgement; air plane field like package tags.

### EXAMPLES

The present invention will be explained with reference to Examples, which are given for no more than illustration of the invention rather than for limiting its intended scope. All percentages and parts are by mass unless indicated otherwise.

### Example 1

Preparation of Thermosensitive Recording Material

(1) Preparation of Coating Liquid for Thermosensitive Recording Layer

A liquid

| | |
|---|---|
| 2-anilino-3-methyl-6-(di-n-butylamino)fluoran | 10 parts |
| 10% itaconic acid-modified PVA aqueous solution | 10 parts |
| water | 30 parts |

B liquid

| | |
|---|---|
| 4-hydroxy-4′-isopropoxydiphenylsulfone | 30 parts |
| tetrabromobisphenol A | 10 parts |
| 10% itaconic acid-modified PVA aqueous solution | 50 parts |
| silica | 15 parts |
| water | 197 parts |

The A and B liquids of the above formulations were each milled and dispersed to an average particle diameter of no more than 1.5 μm using a sand mill thereby to prepare a dye dispersion (A liquid) and a color developer dispersion (B liquid).

Subsequently, a coating liquid for thermosensitive recording layer (C liquid) was prepared by mixing and stirring the two liquids below.

C liquid

| | |
|---|---|
| dye dispersion (A liquid) | 50 parts |
| color developer dispersion (B liquid) | 292 parts |

(2) Preparation of Coating Liquid for Protective Layer

D liquid

| | |
|---|---|
| aluminum hydroxide*¹⁾ | 20 parts |
| 10% itaconic acid-modified PVA aqueous solution | 20 parts |
| water | 60 parts |

*¹⁾average particle diameter: 0.6 μm, Hydilite H-43M, by Showa Denko K. K.

The ingredients shown above were milled and dispersed for 24 hours using a sand mill thereby to prepare D liquid.

E liquid

| | | |
|---|---|---|
| D liquid described above | 75 | parts |
| 10% diacetone-modified PVA aqueous solution | 100 | parts |
| 10% adipic dihydrazide | 15 | parts |
| 45% room temperature-curable silicone rubber | 0.05 | part |
| 1% ammonia aqueous solution | 5 | parts |
| water | 90 | parts |

The ingredients shown above were mixed and stirred thereby to prepare a coating liquid for protective layer of pH 7 (E liquid).

Then the C and E liquids were coated and dried on a support of base paper in coated amounts of 5.0 g/m² and 3.5 g/m² of a thermosensitive recording layer and a protective layer respectively as dry mass. These layers were dried and then subjected to calendaring to about 2000 seconds of surface smoothness by Ohken surface smoothness tester thereby to prepare the thermosensitive recording material of Example 1. The E liquid was dried at 70° C. for 10 seconds.

### Example 2

Preparation of Thermosensitive Recording Material

The thermosensitive recording material of Example 2 was prepared in the same manner as Example 1, except that the amount of 1% ammonia aqueous solution in the E liquid was changed into 10 parts and the coating liquid for protective layer was adjusted to pH 8.

### Example 3

Preparation of Thermosensitive Recording Material

The thermosensitive recording material of Example 3 was prepared in the same manner as Example 1, except that the amount of 1% ammonia aqueous solution in the E liquid was changed into 0.5 part and the coating liquid for protective layer was adjusted to pH 6.

### Example 4

Preparation of Thermosensitive Recording Material

The thermosensitive recording material of Example 4 was prepared in the same manner as Example 1, except that the amounts of D liquid and water in the E liquid were changed into 150 parts and 15 parts respectively.

### Example 5

Preparation of Thermosensitive Recording Material

The thermosensitive recording material of Example 5 was prepared in the same manner as Example 1, except that the aluminum hydroxide in the D liquid was changed into the aluminum hydroxide (average particle diameter: 1.2 μm, Hydilite H-42M, by Showa Denko K. K.).

### Example 6

Preparation of Thermosensitive Recording Material

The thermosensitive recording material of Example 6 was prepared in the same manner as Example 1, except that the amount of 45% room temperature-curable silicone rubber in the E liquid was changed into 0.25 part.

### Example 7

Preparation of Thermosensitive Recording Material

The thermosensitive recording material of Example 7 was prepared in the same manner as Example 1, except that the amounts of 10% adipic dihydrazide and water in the E liquid were changed into 30 parts and 75 parts respectively.

### Example 8

Preparation of Thermosensitive Recording Material

The thermosensitive recording material of Example 8 was prepared in the same manner as Example 1, except that the 2-anilino-3-methyl-6-(di-n-butylamino)fluoran in the A liquid wad changed into 2-anilino-3-methyl-6-(di-n-pentylamino)fluoran.

### Example 9

Preparation of Thermosensitive Recording Material

The thermosensitive recording material of Example 8 was prepared in the same manner as Example 1, except that the 2-anilino-3-methyl-6-(di-n-butylamino)fluoran in the A liquid wad changed into 2-anilino-3-methyl-(N-cyclohexyl-N-methylamino)fluoran.

### Example 10

Preparation of Thermosensitive Recording Material

The thermosensitive recording material of Example 10 was prepared in the same manner as Example 1, except that the 4-hydroxy-4′-isopropoxydiphenylsulfone in the B liquid was changed into bisphenol A.

### Example 11

Preparation of Thermosensitive Recording Material

The thermosensitive recording material of Example 11 was prepared in the same manner as Example 1, except that the coating liquid for under layer of the formula shown below was prepared and coated on the side of the support opposite to the thermosensitive recording layer in a coated amount of 3.0 g/m² as dry mass.

(3) Preparation of Coating Liquid for Under Layer

| | |
|---|---|
| fine spherical hollow plastic particles*¹⁾ | 36 parts |
| latex of styrene/butadiene copolymer*²⁾ | 10 parts |
| water | 54 parts |

*¹⁾copolymer resin based on styrene/acryl, solid content: 27.5%, average particle diameter: 1 μm, hollow rate: 50%
*²⁾solid content: 47.5%

### Example 12

Preparation of Thermosensitive Recording Material

The thermosensitive recording material of Example 12 was prepared in the same manner as Example 1, except that 1.5 parts of 20% 4,4′-diaminostilbene-2,2′-disulfonic acid derivative was added to the E liquid.

### Example 13

Preparation of Thermosensitive Recording Material

The thermosensitive recording material of Example 13 was prepared in the same manner as Example 1, except that the coating liquid for back layer of the formula shown below was prepared and coated on the side of the support opposite to the thermosensitive recording layer in a coated amount of 1.5 g/m² as dry mass.

(4) Preparation of Coating Liquid for Back Layer

| | |
|---|---|
| D Liquid | 50 parts |
| 10% PVA aqueous solution | 100 parts |
| 10% polyamide epichlorohydrin | 30 parts |
| water | 100 parts |

### Example 14

Preparation of Thermosensitive Recording Material

The thermosensitive recording material of Example 14 was prepared in the same manner as Example 1, except that the pH of the E liquid was adjusted to 5.5.

### Example 15

Preparation of Thermosensitive Recording Material

The thermosensitive recording material of Example 15 was prepared in the same manner as Example 1, except that the pH of the E liquid was adjusted to 8.5.

### Comparative Example 1

Preparation of Thermosensitive Recording Material

The thermosensitive recording material of Comparative Example 1 was prepared in the same manner as Example 1, except that the amount of 1% ammonia aqueous solution in the E liquid was changed into zero part.

### Comparative Example 2

Preparation of Thermosensitive Recording Material

The thermosensitive recording material of Comparative Example 2 was prepared in the same manner as Example 1, except that the 10% diacetone-modified PVA aqueous solution in the E liquid was changed into 10% itaconic acid-modified PVA aqueous solution.

### Comparative Example 3

Preparation of Thermosensitive Recording Material

The thermosensitive recording material of Comparative Example 3 was prepared in the same manner as Example 1, except that the 10% adipic dihydrazide in the E liquid was changed into 10% polyamide epichlorohydrin.

### Comparative Example 4

Preparation of Thermosensitive Recording Material

The thermosensitive recording material of Comparative Example 4 was prepared in the same manner as Example 1, except that the 10% diacetone-modified PVA aqueous solution in the E liquid was changed into, 10% diacetone acrylamide copolymer-modified PVA aqueous solution.

The resulting thermosensitive recording materials were evaluated in terms of the following properties. The results are shown in Table 1.

Coloring Property

The resulting thermosensitive recording materials were printed using a thermosensitive recording-evaluation device (TH-PMD, by Okura Electric Co.) in a condition of printing energy 0.45 W/dot, recording period 20 msec/line, pulse width 0.2 to 1.0 msec and pulse frequency 1 msec; then the resulting printing densities were measured using Macbeth densitometer (Model RD-914, by GretagMacbeth Co.) and the pulse widths, which corresponding to density 1.0, were determined.

Transporting Ability under High Temperature and Humidity

Printing lengths were measured under a condition of temperature 40° C. and RH 95% using a printer (TM-T8811, by Seiko Epson Co.).

Plasticizer Resistance

Each of the thermosensitive recording materials was colored by way of contacting with a hot stamp at 150° C. for one second then was overlapped with three sheets of polyvinyl chloride wrap, which was then stored for 24 hours with a load of 5 kg/100 cm² under dry condition at 40° C., thereafter the image density was measured using Macbeth densitometer (Model RD-914, by GretagMacbeth Co.).

Thermal Resistance

Each of the thermosensitive recording materials was colored by way of contacting with a hot stamp at 150° C. for one second, then was stored for 24 hours under dry condition at 80° C., thereafter the background portion was measured using Macbeth densitometer (Model RD-914, by GretagMacbeth Co.).

Pot Life of Coating Liquid for Protective Layer

Each of the coating liquids for protective layer was visually observed at room temperature after 48 hours from its preparation with respect to the appearance such as gelatinization.

TABLE 1

| | | Coloring | | | | |
|---|---|---|---|---|---|---|
| | | Property | Transporting | Plasticizer | Thermal | Pot Life of |
| | Resin | (msec) | Ability (mm) | Resistance | Resistance | Coating Liquid |
| Ex. 1 | PVA1 | 0.59 | 102 | 1.35 | 0.15 | no GL till 48 hr |
| Ex. 2 | PVA1 | 0.59 | 102 | 1.34 | 0.15 | no GL till 48 hr |
| Ex. 3 | PVA1 | 0.59 | 102 | 1.35 | 0.16 | no GL till 48 hr |
| Ex. 4 | PVA1 | 0.60 | 103 | 1.27 | 0.15 | no GL till 48 hr |
| Ex. 5 | PVA1 | 0.59 | 103 | 1.29 | 0.15 | no GL till 48 hr |
| Ex. 6 | PVA1 | 0.61 | 103 | 1.36 | 0.16 | no GL till 48 hr |
| Ex. 7 | PVA1 | 0.60 | 103 | 1.34 | 0.15 | no GL till 48 hr |
| Ex. 8 | PVA1 | 0.59 | 101 | 1.32 | 0.15 | no GL till 48 hr |
| Ex. 9 | PVA1 | 0.61 | 103 | 1.28 | 0.20 | no GL till 48 hr |
| Ex. 10 | PVA1 | 0.64 | 101 | 1.25 | 0.32 | no GL till 48 hr |
| Ex. 11 | PVA1 | 0.52 | 103 | 1.37 | 0.16 | no GL till 48 hr |
| Ex. 12 | PVA1 | 0.59 | 102 | 1.36 | 0.17 | no GL till 48 hr |
| Ex. 13 | PVA1 | 0.59 | 103 | 1.35 | 0.16 | no GL till 48 hr |
| Ex. 14 | PVA1 | 0.59 | 102 | 1.35 | 0.16 | some GL after 48 hr |
| Ex. 15 | PVA1 | 0.59 | 102 | 1.35 | 0.15 | some GL after 48 hr |
| Com. Ex. 1 | PVA1 | 0.60 | 103 | 1.34 | 0.17 | GL after 3 hr |
| Com. Ex. 2 | PVA1 | 0.62 | 10 | 1.25 | 0.16 | no GL till 48 hr |
| Com. Ex. 3 | PVA1 | 0.60 | 90 | 1.28 | 0.16 | GL after 15 hr |
| Com. Ex. 4 | PVA2 | 0.61 | 95 | 1.30 | 0.15 | no GL till 48 hr |

PVA1: diacetone-modified PVA
PVA2: diacetone acrylamide copolymer-modified PVA
GL: gelatinization of coating liquid
hr: hour

The thermosensitive recording materials according to the present invention may exhibit superior temporal stability of protective layer-coating liquid, proper transporting ability at printing under higher temperatures and humidities even by use of printers with lower motor torque, and also excellent coloring property and storage property at image and background portions, therefore, may lead to simple mechanism and compactness of thermosensitive recording apparatuses and also easy-handling and inexpensive materials, as such, may be used in a wide variety of fields such as information processing field like output of computers, recorder field like medical meters, facsimile field of lower and higher speed, automatic ticketing field like train and entrance tickets, thermosensitive copy field, label field of POS systems and tag field.

What is claimed is:

1. A thermosensitive recording material, comprising at least a support, a thermosensitive recording layer and a protective layer in order,
wherein the thermosensitive recording layer comprises at least a leuco dye and a color developer, and
the protective layer is formed from a protective layer-coating liquid comprising at least a diacetone-modified polyvinyl alcohol, a carbodihydrazide compound and an aqueous ammonia solution.

2. The thermosensitive recording material according to claim 1, wherein the ammonia content in the protective layer-coating liquid is 0.0005 to 0.01 part by mass based on one part by mass of the diacetone-modified polyvinyl alcohol.

3. The thermosensitive recording material according to claim 1, wherein pH of the protective layer-coating liquid is 6 to 8.

4. The thermosensitive recording material according to claim 1, wherein the coated amount of the protective layer-coating liquid is 1.0 to 5.0 g/m² as dry mass.

5. The thermosensitive recording material according to claim 1, wherein the carbodihydrazide compound comprises adipic dihydrazide, and the content of the carbodihydrazide compound in the protective layer is 0.1 to 0.3 part by mass based on one part by mass of the diacetone-modified polyvinyl alcohol.

6. The thermosensitive recording material according to claim 1, wherein the protective layer comprises a pigment, the pigment comprises aluminum hydroxide having an average particle diameter of 0.5 to 2.0 μm, and the content of the pigment is 1 to 3 parts by mass based on one part by mass of the diacetone-modified polyvinyl alcohol.

7. The thermosensitive recording material according to claim 1, wherein the protective layer comprises a lubricant, the lubricant comprises a room temperature-curable silicone rubber, and the content of the room temperature-curable silicone rubber is 0.01 to 0.1 part by mass based on one part by mass of the diacetone-modified polyvinyl alcohol.

8. The thermosensitive recording material according to claim 1, wherein the protective layer comprises a fluorescent whitening agent, and the fluorescent whitening agent comprises a diaminostilbene compound.

9. The thermosensitive recording material according to claim 1, wherein the leuco dye is one of
2-anilino-3-methyl-6-(di-n-butylamino)fluorane and
2-anilino-3-methyl-6-(di-n-pentylamino)fluorane.

10. The thermosensitive recording material according to claim 1, wherein the color developer comprises a diphenylsulfone compound, and the content of the color developer is 1 to 5 parts by mass based on one part of the leuco dye.

11. The thermosensitive recording material according to claim 1, wherein the thermosensitive recording material further comprises an under layer between the thermosensitive recording material and the protective layer, and the under layer comprises a binder resin and hollow particles.

12. The thermosensitive recording material according to claim 1, wherein the thermosensitive recording material further comprises a back layer on the side of the support opposite to the thermosensitive recording layer.

13. The thermosensitive recording material according to claim 1, wherein the thermosensitive recording material further comprises an adhesive layer on the side of the support opposite to the thermosensitive recording layer, and a release paper is disposed on the adhesive layer, thereby to form a thermosensitive recording label.

14. The thermosensitive recording material according to claim 1, wherein the thermosensitive recording material further comprises a thermosensitive adhesive layer, which being tacky upon heating, on the side of the support opposite to the thermosensitive recording layer, thereby to form a thermosensitive recording label.

15. The thermosensitive recording material according to claim 1, wherein the thermosensitive recording material further comprises a magnetic recording layer on the side of the support opposite to the thermosensitive recording layer, thereby to form a thermosensitive magnetic recording paper.

16. The thermosensitive recording material according to claim 1, having a shape of label, sheet or roll.

17. A method for producing a thermosensitive recording material, comprising at least a support, a thermosensitive recording layer and a protective layer in order,
wherein the protective layer is formed by coating and drying a protective layer-coating liquid on the thermosensitive recording layer, and
the protective layer-coating liquid comprises at least a diacetone-modified polyvinyl alcohol, a carbodihydrazide compound and an aqueous ammonia solution.

18. The method for producing a thermosensitive recording material according to claim 17, wherein the ammonia content in the protective layer-coating liquid is 0.0005 to 0.01 part by mass based on one part by mass of the diacetone-modified polyvinyl alcohol.

19. The method for producing a thermosensitive recording material according to claim 17, wherein pH of the protective layer-coating liquid is 6 to 8.

20. The method for producing a thermosensitive recording material according to claim 17, wherein the coated amount of the protective layer-coating liquid is 1.0 to 5.0 g/m² as dry mass.
